(19) United States
(12) Patent Application Publication
(10) Pub. No.: US 2026/0156351 A1
(43) Pub. Date: Jun. 4, 2026

(54) SHOOTING PARAMETER DETERMINING METHOD AND APPARATUS, DEVICE, AND MEDIUM

(71) Applicant: Beijing Zitiao Network Technology Co., Ltd., Haidian District (CN)

(72) Inventors: Jizhe XIA, Beijing (CN); Guangqi CHEN, Beijing (CN); Yuan GAO, Beijing (CN)

(21) Appl. No.: 19/402,694

(22) Filed: Nov. 26, 2025

(30) Foreign Application Priority Data
Nov. 29, 2024 (CN) 202411751378.5

(51) Int. Cl. H04N 23/60; H04N 23/61

(52) U.S. Cl. CPC H04N 23/64; H04N 23/61

(57) ABSTRACT

The present application discloses a shooting parameter determining method and apparatus, a device, and a medium, which are applied to the field of image processing technology. In the method, a reference image is obtained. The reference image is analyzed to determine an image shooting parameter of the reference image. The image shooting parameter can reflect a shooting parameter used when the reference image is shot. Then, target shooting parameter used by a target device to shoot an image is determined based on the image shooting parameter and a camera parameter of the target device. The target device can be guided, based on the target shooting parameter, to shoot an image with a presentation effect similar to that of the reference image.

### CROSS-REFERENCE TO RELATED APPLICATIONS

This application claims priority to Chinese Patent Application No. 202411751378.5, filed on Nov. 29, 2024. The entire disclosure of the prior application is hereby incorporated by reference in its entirety.

### TECHNICAL FIELD

The present application relates to the field of image processing technologies, and specifically, to a shooting parameter determining method and apparatus, a device, and a medium.

### BACKGROUND

A mobile device is a commonly used device for a user to shoot an image. When using the mobile device to shoot an image, the user manually adjusts shooting parameters of the mobile device based on a shooting requirement. For example, the user adjusts shooting results of images by adjusting the shooting parameters such as a focal length, exposure, and a shooting angle.

### SUMMARY

The present application provides the following technical solutions.

According to a first aspect, the present application provides a shooting parameter determining method. The method includes:
obtaining a reference image;
determining an image shooting parameter of the reference image; and
determining a target shooting parameter based on the image shooting parameter and a camera parameter of a target device.

In a possible implementation, determining the image shooting parameter of the reference image includes:
determining a first perspective field parameter of the reference image;
determining a first correspondence between a simulated shooting parameter and a second perspective field parameter based on a simulated camera parameter; and
determining the image shooting parameter based on the first perspective field parameter and the first correspondence.

In a possible implementation, determining the first perspective field parameter of the reference image includes:
invoking an image processing model to process the reference image, to obtain the first perspective field parameter output by the image processing model.

In a possible implementation, determining the first correspondence between the simulated shooting parameter and the second perspective field parameter based on the simulated camera parameter includes:
constructing a camera model based on the simulated camera parameter, where the camera model is configured to describe a correspondence between a camera coordinate system and a pixel coordinate system; and
determining the first correspondence based on the camera model and a simulated gravity direction.

In a possible implementation, the image shooting parameter includes an image focal length, and determining the target shooting parameter based on the image shooting parameter and the camera parameter of the target device includes:
determining a target focal length of the target device based on the image focal length and a standard focal length of the target device.

In a possible implementation, the image shooting parameter includes an image pitch angle, and determining the target shooting parameter based on the image shooting parameter and the camera parameter of the target device includes:
determining a target pitch angle of the target device based on the image pitch angle and a gravity direction of the target device.

According to a second aspect, the present application provides a shooting parameter determining apparatus. The apparatus includes:
an obtaining unit configured to obtain a reference image;
a first determining unit configured to determine an image shooting parameter of the reference image; and
a second determining unit configured to determine a target shooting parameter based on the image shooting parameter and a camera parameter of a target device.

In a possible implementation, the first determining unit is specifically configured to: determine a first perspective field parameter of the reference image;
determine a first correspondence between a simulated shooting parameter and a second perspective field parameter based on a simulated camera parameter; and
determine the image shooting parameter based on the first perspective field parameter and the first correspondence.

In a possible implementation, that the first determining unit is configured to determine the first perspective field parameter of the reference image includes that:
the first determining unit is configured to invoke an image processing model to process the reference image, to obtain the first perspective field parameter output by the image processing model.

In a possible implementation, that the first determining unit is configured to determine the first correspondence between the simulated shooting parameter and the second perspective field parameter based on the simulated camera parameter includes that:
the first determining unit is configured to construct a camera model based on the simulated camera parameter, where the camera model is configured to describe a correspondence between a camera coordinate system and a pixel coordinate system; and determine the first correspondence based on the camera model and a simulated gravity direction.

In a possible implementation, the image shooting parameter includes an image focal length, and the second determining unit is specifically configured to:
determine a target focal length of the target device based on the image focal length and a standard focal length of the target device.

In a possible implementation, the image shooting parameter includes an image pitch angle, and the second determining unit is specifically configured to:
determine a target pitch angle of the target device based on the image pitch angle and a gravity direction of the target device.

According to a third aspect, the present application provides an electronic device. The electronic device includes a processor and a memory. The processor and the memory communicate with each other. The processor is configured to execute instructions stored in the memory, to cause the electronic device to perform a shooting parameter determining method according to the first aspect or any one of the implementations of the first aspect.

According to a fourth aspect, the present application provides a computer-readable storage medium. The computer-readable storage medium stores instructions that instruct an electronic device to perform a shooting parameter determining method according to the first aspect or any one of the implementations of the first aspect.

According to a fifth aspect, the present application provides a computer program product including instructions. The computer program product, when running on an electronic device, causes the electronic device to perform a shooting parameter determining method according to the first aspect or any one of the implementations of the first aspect.

In the present application, based on the implementations according to the above-mentioned aspects, the implementations may be further combined to provide more implementations.

### BRIEF DESCRIPTION OF THE DRAWINGS

FIG. 1 is a schematic diagram of an example of an application scenario according to some embodiments of the present application;

FIG. 2 is a flowchart of a shooting parameter determining method according to some embodiments of the present application;

FIG. 3 is a flowchart of another shooting parameter determining method according to some embodiments of the present application;

FIG. 4 is a schematic structural diagram of a pinhole camera according to some embodiments of the present application;

FIG. 5 is a schematic structural diagram of a shooting parameter determining apparatus according to some embodiments of the present application; and

FIG. 6 is a schematic diagram of a basic structure of an electronic device according to some embodiments of the present application.

### DETAILED DESCRIPTION

To facilitate understanding and explanation of the technical solutions according to embodiments of the present application, the background art of the present application is first described below.

A mobile device usually has a shooting function, so that a user can use the mobile device to shoot an image. The mobile device further provides a function of configuring shooting parameters. The user may adjust the shooting parameters to adjust shooting results of images. For example, the user may adjust an image zoom level by adjusting a focal length. The user may adjust image composition by adjusting a shooting angle. The user may adjust image brightness by adjusting exposure.

Currently, the shooting parameters are mainly adjusted based on shooting experience of the user. In some possible cases, the user may need to manually adjust the shooting parameters multiple times, evaluating shooting results of images corresponding to different shooting parameters, in order to obtain an image with a better shooting result. If the user lacks the shooting experience, the shooting parameters selected by the user cannot meet an image shooting requirement, and the cost for the user to adjust the shooting parameters and shoot an image is high, resulting in poor shooting experience for the user. In some other possible cases, shooting parameters configured by the user may fail to deliver a satisfactory shooting result for the user, also resulting in poor shooting experience for the user.

In view of this, the present application provides a shooting parameter determining method and apparatus, a device, and a medium, which can provide shooting guidance for a user and improve shooting experience of the user. In the method, a reference image is obtained. The reference image is an aesthetically pleasing image used as a reference in a case where a user uses a target device to shoot an image. The reference image is analyzed to determine an image shooting parameter of the reference image. The image shooting parameter can reflect a shooting parameter used in a case where the reference image is shot. Then, a target shooting parameter used by the target device to shoot an image is determined based on the image shooting parameter and a camera parameter of the target device. In this way, the target shooting parameter configured to guide the target device to shoot an image similar to the reference image can be determined by analyzing the reference image, eliminating the need for the user to manually analyze the reference image or manually adjust shooting parameter of the target device through a plurality of attempts. This reduces the operation cost for the user to shoot an image with reference to the reference image, improves the image shooting experience of the user using the target device, and enables the image shot by the user to be more aesthetically pleasing.

It can be learned that the present application has the following beneficial effects: the present application provides a shooting parameter determining method and apparatus, a device, and a medium. In the method, a reference image is obtained. The reference image is used as a reference in a case where the user uses a target device to shoot an image. The reference image is analyzed to determine an image shooting parameter of the reference image. The image shooting parameter reflects a shooting parameter used in a case where the reference image is shot. Then, a target shooting parameter used by a target device to shoot an image is determined based on the image shooting parameter and a camera parameter of the target device. In this way, the target shooting parameter used in a case where an image similar to the reference image is shot can be determined for the target device by analyzing the reference image, eliminating the need for the user to manually analyze the reference image or manually adjust a device shooting parameter of the target device through a plurality of attempts. This reduces the operation cost for the user to shoot an image with reference to the reference image, improves the image shooting experience of the user using the target device, and enables the image shot by the user to be more aesthetically pleasing.

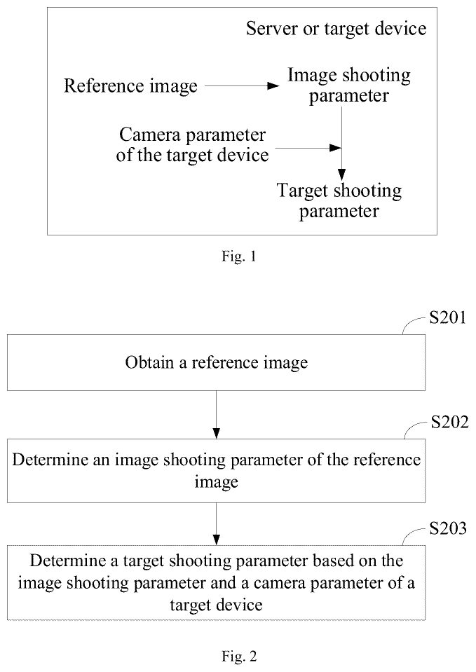

To facilitate understanding of the shooting parameter determining method according to some embodiments of the present application, the shooting parameter determining method according to some embodiments of the present application is described with reference to the accompanying drawings and a scenario example shown in FIG. 1. FIG. 1 is a schematic diagram of an example of an application scenario according to some embodiments of the present application.

As an example, the shooting parameter determining method according to some embodiments of the present application can be applied to a server. The server may be a cloud server, for example, a server in a computing cluster or an edge server in an edge computing cluster. Certainly, the server may alternatively be a local server, which is not limited in embodiments of the present application.

The server is connected to a client of a target device. The client of the target device provides an image shooting service for the user.

The server obtains a reference image. The reference image is an image as a reference for the target device to shoot an image. The reference image is, for example, an image generated by a device other than the target device.

The reference image is, for example, an image selected by the user through the client of the target device. The client of the target device sends the reference image to the server. The server obtains the reference image sent by the client.

The server determines an image shooting parameter of the reference image. A target shooting parameter of the target device can be determined by using the image shooting parameter. The server obtains the camera parameter of the target device. The server determines the target shooting parameter of the target device based on the camera parameter of the target device and the image shooting parameter. The target shooting parameter is configured to guide the user to shoot, using the target device, an image with a shooting result similar to that of the reference image. Further, the server may configure a device shooting parameter of the target device based on the target shooting parameter. As an example, the server sends a parameter configuration instruction to the user. The parameter configuration instruction includes the target shooting parameter. The client may automatically set the device shooting parameter of the target device to the target shooting parameter according to the parameter configuration instruction. As another example, the server sends the target shooting parameter to the client of the target device. The client of the target device displays the target shooting parameter, so that the user can manually adjust the device shooting parameter of the target device based on the displayed target shooting parameter.

As another example, the shooting parameter determining method according to some embodiments of the present application can be applied to the target device. The target device may be a mobile terminal having an image shooting function.

The target device obtains a reference image. The reference image can be generated by another device, or a server, or the target device itself. The target device determines an image shooting parameter of the reference image. The target device obtains its own camera parameter. The target device determines a target shooting parameter based on the camera parameter and the image shooting parameter. Further, the target device may configure a device shooting parameter based on the target shooting parameter. As an example, the target device displays the target shooting parameter, so that the user can manually adjust the device shooting parameter of the target device based on the target shooting parameter. Alternatively, as another example, the target device automatically adjusts the device shooting parameter based on the target shooting parameter.

The device shooting parameter of the target device is determined based on the reference image, helping the user shoot, using the target device, an image with a shooting result similar to that of the reference image. On the basis of reducing the operation cost for the user, an image shooting requirement of the user is met, and the operating experience of the user is improved.

Those skilled in the art may understand that the above-mentioned two application scenarios are merely examples in which implementations of the present application can be implemented. The scope of application of the implementations of the present application is not limited by the above-mentioned application scenarios in any aspect.

To facilitate understanding of the technical solution according to some embodiments of the present application, the shooting parameter determining method according to some embodiments of the present application is described below with reference to the accompanying drawings.

FIG. 2 is a flowchart of a shooting parameter determining method according to some embodiments of the present application. As shown in FIG. 2, the method may include steps S201 to S203.

S201: Obtain a reference image.

The reference image is an image serving as a reference.

The reference image may be generated by a device having an image shooting function. For example, the reference image may be an image of a type such as a portrait image or a landscape image. As another example, the reference image is generated by a device having an image processing function. The device having an image processing function can generate the reference image based on obtained images, text, or other information. The reference image may be an image generated by a device different from the target device. That is, an image generated by another device is used as the reference image in a case where the target device shoots an image. The reference image may alternatively be an image generated by the target device. For example, an image historically shot by the target device is used as the reference image in a case where an image is currently shot.

The reference image may be an image provided by a user using the target device. In some possible implementation scenarios, a reference image input by the user is obtained. In some other possible implementation scenarios, candidate images available for the user to select are obtained in advance. The candidate images may be stored in an image library. At least one candidate image is displayed to the user, so that the user can select a reference image from the candidate images. A selection instruction triggered by the user through the target device is obtained. The selection instruction is configured to indicate the candidate image selected by the user. The candidate image selected by the user is determined according to the selection instruction, and the candidate image selected by the user is used as the reference image.

S202: Determine an image shooting parameter of the reference image.

The reference image is generated based on specific image shooting parameters. The image shooting parameters are parameters related to image shooting elements such as an image distance and an image angle. Specific content included in the image shooting parameters are not limited in embodiments of the present application. As an example, the image shooting parameters include one or more of a focal length and a pitch angle.

In a possible implementation, the reference image is processed using a preset model, to generate the image shooting parameter of the reference image.

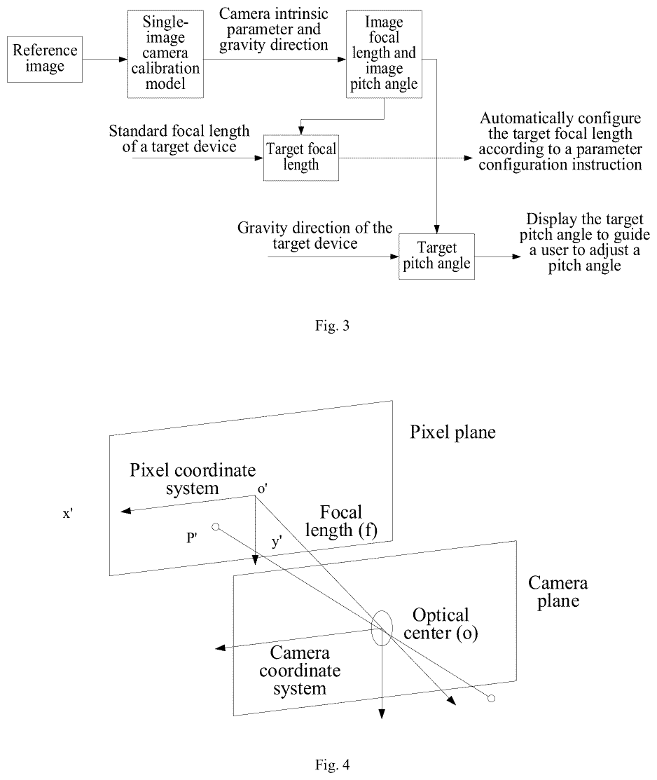

As an example, the preset model is a single-image camera calibration model. FIG. 3 is a flowchart of another shooting parameter determining method according to some embodiments of the present application.

As an example, the single-image camera calibration model is, for example, a model constructed based on a related image processing algorithm. The single-image camera calibration model processes an input image by combining geometric optimization with deep learning, and estimates camera intrinsic parameters and a gravity direction corresponding to the input image.

The camera intrinsic parameter is a type of camera parameter. The camera intrinsic parameters are parameters describing internal attributes of a camera, including a focal length, principal point (optical center) coordinates, a distortion coefficient, etc. The camera intrinsic parameters affect the quality of an image shot by the camera. The camera intrinsic parameters are usually determined during camera calibration, and for a specific type of target device, the camera intrinsic parameters are fixed. The camera intrinsic parameters are usually represented by a 3×3 matrix, including information such as a focal length, principal point coordinates, and a pixel size. The camera intrinsic parameters determine a shape and size of a two-dimensional image obtained by the camera from a three-dimensional scene.

The gravity direction may also be referred to as a gravity vector. The gravity direction represents the direction of gravitational force on the earth surface, generally pointing toward the center of the earth. The gravity direction is configured to determine an absolute orientation of the camera, assisting in the camera calibration process.

An example in which the image shooting parameters include an image focal length and an image pitch angle is used. The single-image camera calibration model is invoked to process the reference image, to obtain the camera intrinsic parameters and the gravity direction. The camera intrinsic parameters include the image focal length. The image pitch angle is determined based on the gravity direction.

Further, the image focal length included in the camera intrinsic parameters is expressed in pixels, and needs to be converted into an image focal length in millimeters (mm). For a conversion formula, refer to Formula (1):

$$f = {f}_{p} \times \frac{{s}_{x}}{{p}_{x}} \qquad ( 1 )$$

where f is the focal length in millimeters, fₚ is the focal length in pixels, sₓ is a width of an image sensor in millimeters, and pₓ is a pixel width of an image.

As an example, for a conversion process of an equivalent focal length f_{35 mm} of 35 mm, refer to Formula (2):

$${f}_{35 mm} = f \times \frac{36 mm}{h} \qquad ( 2 )$$

where h is a pixel width of an image, and 36 mm means that an image width of a 35 mm film is 36 mm. Formula (2) may alternatively be equivalently expressed as Formula (3).

$${f}_{35 mm} = \frac{36 mm}{2 \times tan ( FOV / 2 )} \qquad ( 3 )$$

where a field of view (FOV) is an angle range within which the camera can receive an image.

In addition, some embodiments of the present application further provide a calculation formula for determining the image pitch angle based on the gravity direction, as shown in Formula (4).

$$pitch = - arctan ( {a}_{x} / \sqrt{{a}_{y}^{2} + {a}_{z}^{2}} ) \qquad ( 4 )$$

where pitch is the image pitch angle, aₓ is a gravitational component on an x-axis, a_{y} is a gravitational component on a y-axis, and a_{z} is a gravitational component on a z-axis. The z-axis is perpendicular to and in an opposite direction of gravity, and the x-axis and y-axis are on a plane perpendicular to the z-axis. The x-axis is perpendicular to the y-axis.

In another possible implementation, some embodiments of the present application provide an implementation for determining the image shooting parameter of a reference image. The implementation includes the following three steps.

A1: Determine a first perspective field parameter of the reference image.

The perspective field parameter is configured to describe a perspective attribute of the image. The perspective field parameter includes information about each pixel relative to a camera view. Each pixel corresponds to a projection (up_vector) of a vertically upward direction vector on a two-dimensional image and a latitude relative to the horizon. The latitude represents an included angle between the horizon and a line connecting a current pixel to the optical center of the camera.

An implementation for determining the first perspective field parameter of the reference image is not limited in embodiments of the present application. In a possible implementation, an image processing model is invoked to process the reference image, to obtain the first perspective field parameter. The image processing model is a pre-trained model that is configured to process an input image and output a perspective field parameter of the input image.

A2: Determine a first correspondence between a simulated shooting parameter and a second perspective field parameter based on a simulated camera parameter.

The simulated camera parameter is a camera parameter of a simulated camera. The simulated camera is a camera model constructed based on camera principles configured to simulate a real camera. The image shooting parameter used in a case where the reference image is shot can be determined based on the simulated camera parameter.

The simulated camera parameter includes a camera intrinsic parameter. A camera model is constructed based on the simulated camera parameter. The camera model is configured to describe a correspondence between a camera coordinate system and a pixel coordinate system.

A camera type of the simulated camera is not limited in embodiments of the present application. An example in which the simulated camera is a pinhole camera constructed based on the principle of pinhole imaging is used. FIG. 4 is a schematic structural diagram of a pinhole camera according to some embodiments of the present application. The pinhole camera includes a pixel plane and a camera plane. The pixel plane and the camera plane are parallel, with a distance between them being a focal length.

The pixel plane and the camera plane are both perpendicular to a z-axis. An x′-axis and a y′-axis of the pixel coordinate system are perpendicular to the z-axis. The origin of the camera coordinate system is the optical center of the camera. An x-axis and a y-axis of the camera coordinate system are perpendicular to a z-axis. The x′-axis of the pixel coordinate system is parallel to the x-axis of the camera coordinate system. The y′-axis of the pixel coordinate system is parallel to the y-axis of the camera coordinate system.

For an expression of the camera model constructed based on the simulated camera parameter, refer to Formula (5):

$$( \begin{matrix}u \\ v \\ 1\end{matrix} ) = \frac{1}{z} ( \begin{matrix}{f}_{x} & 0 & {c}_{y} \\ 0 & {f}_{y} & {c}_{y} \\ 0 & 0 & 1\end{matrix} ) ( \begin{matrix}X \\ Y \\ Z\end{matrix} ) {=}^{Δ} \frac{1}{z} KP$$

where the matrix K represents camera intrinsic parameters, the matrix P represents coordinates of a pixel p in the camera coordinate system, and the matrix

$$( \begin{matrix}u \\ v \\ 1\end{matrix} )$$

represents coordinates of the pixel p in the pixel coordinate system.

The simulated shooting parameter is a shooting parameter with a value to be determined. The first correspondence between the simulated shooting parameter and the second perspective field parameter is determined based on the camera model and a simulated gravity direction.

The first correspondence includes Formula (6) and Formula (7).

$${u}_{p} = {lim}_{t \to 0} \frac{Π ( P - tg ) - Π ( P )}{{‖ Π ( P - tg ) - Π ( P ) ‖}_{2}} \qquad ( 6 )$$

$${φ}_{p} = arcsin ( \frac{{n}^{T} g}{{‖ n ‖}_{2}} ) \qquad ( 7 )$$

where the matrix P is three-dimensional world coordinates corresponding to the pixel p, g is the simulated gravity direction, Π represents the camera model, uₚ is the up_vector of the pixel p, n is a direction vector from the optical center of the camera to the pixel p, and φₚ is a latitude of the pixel p.

A3: Determine the image shooting parameter based on the first perspective field parameter and the first correspondence.

The image shooting parameter is determined based on the first correspondence between the simulated shooting parameter and the second perspective field parameter that is determined in step A2, along with the first perspective field parameter.

As an example, the second perspective field parameter is set to the first perspective field parameter. A value of the simulated shooting parameter is determined based on the first correspondence, to obtain the image shooting parameter.

As another example, the value of the simulated shooting parameter is adjusted. In response to a difference between the second perspective field parameter and the first perspective field parameter being less than a difference threshold, the simulated shooting parameter with a determined value is used as the image shooting parameter. The difference threshold is a preset threshold configured to determine the image shooting parameter.

S203: Determine a target shooting parameter based on the image shooting parameter and a camera parameter of a target device.

The image shooting parameter determined in step S202 is a shooting parameter determined in an image dimension. A shooting parameter in a device dimension, namely a target shooting parameter of the target device, is determined based on the image shooting parameter, to guide the user to shoot an image using the target device.

As an example, the camera parameters of the target device include one or more of the following three types of parameters: camera intrinsic parameters, camera extrinsic parameters, and a gravity direction.

The camera extrinsic parameters are parameters describing a position and attitude of the camera in a world coordinate system, usually including a rotation matrix and a translation vector. The camera extrinsic parameters affect a viewing angle and position of the camera relative to an object being shot. The camera extrinsic parameters are not fixed parameters. For the same target device, the position and attitude of the camera may vary at different shooting moments, leading to corresponding changes in the camera extrinsic parameters.

The gravity direction of the target device is configured to determine an absolute orientation of the target device. The gravity direction of the target device is obtained, for example, through measurement by an inertial measurement unit (IMU) of the target device. The IMU is configured to measure three-axis attitude angles and acceleration of the target device.

Types of parameters included in the image shooting parameters are identical to types of parameters included in the target shooting parameters. Specific types of parameters included in the camera parameters of the target device may be determined based on the types of the parameters included in the image shooting parameters.

As an example, the image shooting parameter includes the image focal length. The target shooting parameter includes a target focal length. The target focal length is a focal length to be achieved by the target device during shooting an image. The camera parameter of the target device includes a standard focal length of the target device.

The standard focal length of the target device is usually a calibrated focal length of the target device, which is equivalent to a focal length of a 35 mm full-frame camera. The standard focal length of the target device may be obtained based on device information of the target device. The target focal length of the target device is determined based on the standard focal length of the target device and the image focal length. The target focal length is expressed as, for example, a zoom ratio. As an example, with reference to FIG. 3, by using the standard focal length of the target device as a zoom reference for the target device, the zoom ratio of the target device, namely the target focal length, is determined based on the image focal length and the standard focal length.

As another example, the image shooting parameter includes the image pitch angle. The target shooting parameter includes a target pitch angle. The target pitch angle is a pitch angle to be achieved by the target device during shooting an image. The camera parameter of the target device includes the gravity direction of the target device. The target pitch angle of the target device is determined based on the image pitch angle and the gravity direction of the target device. The target pitch angle is, for example, a pitch angle difference. As an example, with reference to FIG. 3, a current pitch angle of the target device is determined based on the gravity direction of the target device. A difference between the image pitch angle and the current pitch angle is calculated to obtain the target pitch angle.

In some possible cases, after the target shooting parameter is determined, a device shooting parameter of the target device may be configured based on the target shooting parameter.

The device shooting parameter of the target device may be current shooting parameter used by the target device during shooting an image, or may be a preset shooting parameter used by the target device during shooting an image each time.

In a possible implementation, the target device displays the target shooting parameter. The user may adjust the device shooting parameter with reference to the target shooting parameter displayed on the target device, to shoot an image using the target device with reference to the reference image. As an example, the target shooting parameter includes the target pitch angle. With reference to FIG. 3, the target device displays the target pitch angle. The user may manually adjust a device attitude of the target device based on the displayed target pitch angle, to adjust the current pitch angle of the target device to the target pitch angle. In this way, guidance is provided for the user to adjust the device shooting parameter, eliminating the need for the user to perform a plurality of attempts. This reduces the operation cost for the user and improves the shooting experience.

In another possible implementation, the device shooting parameter is set to the target shooting parameter. As an example, a parameter configuration instruction is generated based on the target shooting parameter. The parameter configuration instruction includes the target shooting parameter. The target device automatically sets the device shooting parameter to the target shooting parameter according to the parameter configuration instruction. For example, the target shooting parameter includes the target focal length. With reference to FIG. 3, the target device adjusts a current focal length to the target focal length according to the parameter configuration instruction, thereby achieving automatic focal length adjustment. In this way, manual operations of the user can be reduced, thereby reducing the operation cost for the user and improving the shooting experience for the user.

It can be learned based on the above-mentioned content that the target shooting parameter used by the target device during shooting an image is determined by analyzing the reference image. In this way, guidance for shooting an image using the target device can be achieved with reference to shooting results such as a shooting angle and a shooting distance of the reference image, thereby helping the user shoot, using the target device, an image with a shooting result similar to that of the reference image. On the basis of reducing the operation cost for the user, satisfaction of the user with the shot image can be improved, and the user experience can be improved.

Based on the shooting parameter determining method according to the above-mentioned method embodiments, some embodiments of the present application further provide a shooting parameter determining apparatus. The shooting parameter determining apparatus is described below with reference to the accompanying drawings.

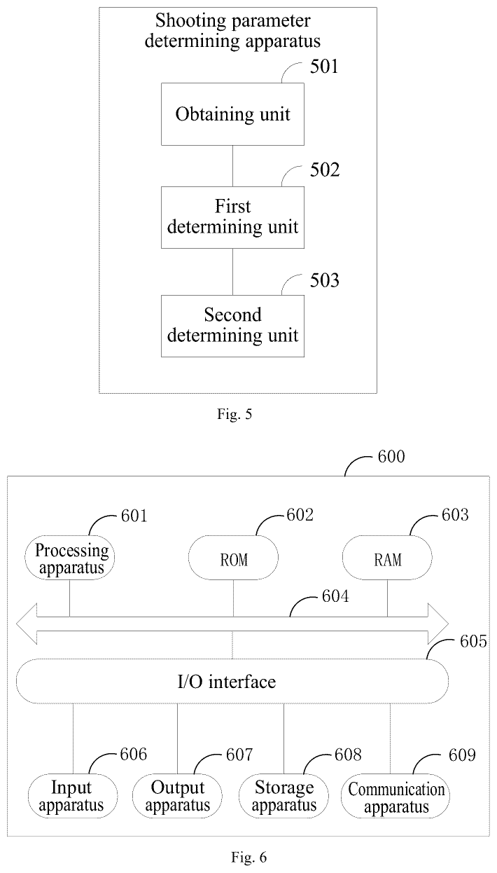

FIG. 5 is a schematic structural diagram of a shooting parameter determining apparatus according to some embodiments of the present application. As shown in FIG. 5, the shooting parameter determining apparatus includes:
an obtaining unit 501 configured to obtain a reference image;
a first determining unit 502 configured to determine an image shooting parameter of the reference image; and
a second determining unit 503 configured to determine a target shooting parameter based on the image shooting parameter and a camera parameter of a target device.

In a possible implementation, the first determining unit 502 is specifically configured to:
determine a first perspective field parameter of the reference image;
determine a first correspondence between a simulated shooting parameter and a second perspective field parameter based on a simulated camera parameter; and
determine the image shooting parameter based on the first perspective field parameter and the first correspondence.

In a possible implementation, that the first determining unit 502 is configured to determine the first perspective field parameter of the reference image includes that:
the first determining unit 502 is configured to invoke an image processing model to process the reference image, to obtain the first perspective field parameter output by the image processing model.

In a possible implementation, that the first determining unit 502 is configured to determine the first correspondence between the simulated shooting parameter and the second perspective field parameter based on the simulated camera parameter includes that:
the first determining unit 502 is configured to construct a camera model based on the simulated camera parameter, where the camera model is configured to describe a correspondence between a camera coordinate system and a pixel coordinate system; and determine the first correspondence based on the camera model and a simulated gravity direction.

In a possible implementation, the image shooting parameter includes an image focal length, and the second determining unit 503 is specifically configured to:
determine a target focal length of the target device based on the image focal length and a standard focal length of the target device.

In a possible implementation, the image shooting parameter includes an image pitch angle, and the second determining unit 503 is specifically configured to:
determine a target pitch angle of the target device based on the image pitch angle and a gravity direction of the target device.

Reference is made to FIG. 6 below, which is a schematic structural diagram of an electronic device 600 suitable for implementing embodiments of the present application. The terminal device in embodiments of the present application may include, but is not limited to, mobile terminals such as a mobile phone, a notebook computer, a digital broadcast receiver, a personal digital assistant (PDA), a portable Android device (PAD), a portable media player (PMP), and a vehicle-mounted terminal (such as a vehicle navigation terminal), and fixed terminals such as a digital television (TV) and a desktop computer. The electronic device shown in FIG. 6 is merely an example, and shall not impose any limitation on the function and scope of use of embodiments of the present application.

As shown in FIG. 6, the electronic device 600 may include a processing apparatus (for example, a central processing unit or a graphics processing unit) 601 that may perform a variety of appropriate actions and processing in accordance with a program stored in a read-only memory (ROM) 602 or a program loaded from a storage apparatus 608 into a random-access memory (RAM) 603. The RAM 603 further stores various programs and data required for operations of the electronic device 600. The processing apparatus 601, the ROM 602, and the RAM 603 are connected to one another through a bus 604. An input/output (I/O) interface 605 is also connected to the bus 604.

Generally, the following apparatus may be connected to the I/O interface 605: an input apparatus including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a magnetic tape and a hard disk drive; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to some embodiments of the present application, the process described above with reference to the flowchart may be implemented as a computer software program. For example, some embodiments of the present application include a computer program product, which includes a computer program carried on a non-transitory computer-readable medium, where the computer program includes program code for performing the method shown in the flowchart. In such an embodiment, the computer program may be downloaded and installed from a network through the communication apparatus 609, installed from the storage apparatus 608, or installed from the ROM 602. The computer program, when executed by the processing apparatus 601, causes the above-mentioned functions defined in the method according to embodiments of the present application to be performed.

The electronic device according to some embodiments of the present application and the shooting parameter determining method according to the above-mentioned embodiments belong to the same inventive concept. For the technical details not exhaustively described in this embodiment, reference may be made to the above-mentioned embodiments, and this embodiment and the above-mentioned embodiments have the same beneficial effects.

Based on the shooting parameter determining method according to the above-mentioned method embodiments, some embodiments of the present application provide a computer storage medium storing a computer program that, when executed by a processor, causes the shooting parameter determining method according to any one of the above-mentioned embodiments to be implemented.

It should be noted that the above-mentioned computer-readable medium described in the present application may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of computer-readable storage media may include, but are not limited to: an electrical connection having one or more wires, a portable computer magnetic disk, a hard disk drive, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present application, the computer-readable storage medium may be any tangible medium including or storing a program which may be used by or in combination with an instruction execution system, apparatus, or device. In the present application, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code included in the computer-readable medium may be transmitted by any suitable medium, including but not limited to: electric wires, optical cables, radio frequency (RF), and the like, or any suitable combination thereof.

In some implementations, a client or a server may perform communication by using any currently known or future-developed network protocol such as a hypertext transfer protocol (HTTP), and may interconnect with digital data communication (e.g., a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above-mentioned computer-readable medium may be included in the above-mentioned electronic device. Alternatively, the computer-readable medium may exist independently, without being assembled into the electronic device.

The above-mentioned computer-readable medium carries one or more programs that, when executed by the electronic device, cause the electronic device to perform the above-mentioned shooting parameter determining method.

The computer program code for performing the operations of the present application may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with an Internet service provider).

The flowchart and the block diagram in the accompanying drawings illustrate the possibly implemented architecture, functions, and operations of the system, method, and computer program product according to embodiments of the present application. In this regard, each block in the flowchart or block diagram may represent a module, program segment, or part of code, and the module, program segment, or part of code includes one or more executable instructions configured to implement the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in embodiments of the present application may be implemented by software, or may be implemented by hardware. The name of a unit/module does not constitute a limitation on the unit itself in some cases. For example, a speech data collection module may alternatively be described as a “data collection module”.

The functions described herein above-mentioned may be performed at least partially by one or more hardware logic components. For example, without limitation, example types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present application, a machine-readable medium may be a tangible medium that may include or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on differences from other embodiments. The same or similar parts between the various embodiments may be referenced to each other. For the system or apparatus disclosed in the embodiments, since it corresponds to the method disclosed in the embodiments, the description is relatively simple, and for the related parts, reference may be made to the description of the method.

It should be understood that, in the present application, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions means any combination of these items, including any combination of single items or plural items. For example, at least one of a, b, or c may indicate: a, b, c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include”, “comprise”, or any other variants thereof are intended to cover a non-exclusive inclusion, so that a process, a method, an article, or a device that includes a list of elements not only includes those elements but also includes other elements that are not listed, or further includes elements inherent to such a process, method, article, or device. In the absence of more restrictions, an element defined by “including a . . . ” does not exclude another identical element in a process, method, article, or device that includes the element.

With respect to the above-mentioned description of the disclosed embodiments, those skilled in the art could implement or use the present application. Various modifications to these embodiments are apparent to those skilled in the art, and the general principle defined herein may be practiced in other embodiments without departing from the spirit or scope of the present application. Therefore, the present application is not limited to the embodiments described herein but is to be accorded with the broadest scope consistent with the principle and novel features disclosed herein.

What is claimed is:

1. A shooting parameter determining method, wherein the method comprises:
obtaining a reference image;
determining an image shooting parameter of the reference image; and
determining a target shooting parameter based on the image shooting parameter and a camera parameter of a target device.

2. The method according to claim 1, wherein the determining the image shooting parameter of the reference image comprises:
determining a first perspective field parameter of the reference image;
determining a first correspondence between a simulated shooting parameter and a second perspective field parameter based on a simulated camera parameter; and
determining the image shooting parameter based on the first perspective field parameter and the first correspondence.

3. The method according to claim 2, wherein the determining the first perspective field parameter of the reference image comprises:
invoking an image processing model to process the reference image, to obtain the first perspective field parameter output by the image processing model.

4. The method according to claim 2, wherein the determining the first correspondence between the simulated shooting parameter and the second perspective field parameter based on the simulated camera parameter comprises:
constructing a camera model based on the simulated camera parameter, wherein the camera model is configured to describe a correspondence between a camera coordinate system and a pixel coordinate system; and
determining the first correspondence based on the camera model and a simulated gravity direction.

5. The method according to claim 1, wherein the image shooting parameter comprises an image focal length, and the determining the target shooting parameter based on the image shooting parameter and the camera parameter of the target device comprises:
determining a target focal length of the target device based on the image focal length and a standard focal length of the target device.

6. The method according to claim 1, wherein the image shooting parameter comprises an image pitch angle, and the determining the target shooting parameter based on the image shooting parameter and the camera parameter of the target device comprises:
determining a target pitch angle of the target device based on the image pitch angle and a gravity direction of the target device.

7. An electronic device, wherein the electronic device comprises a processor and a memory, wherein
the processor is configured to execute instructions stored in the memory, to cause the electronic device to perform a method comprising:
obtaining a reference image;
determining an image shooting parameter of the reference image; and
determining a target shooting parameter based on the image shooting parameter and a camera parameter of a target device.

8. The electronic device according to claim 7, wherein the processor is configured to execute following steps:
determine a first perspective field parameter of the reference image;
determine a first correspondence between a simulated shooting parameter and a second perspective field parameter based on a simulated camera parameter; and
determine the image shooting parameter based on the first perspective field parameter and the first correspondence.

9. The electronic device according to claim 8, wherein the processor is configured to execute a following step:
invoke an image processing model to process the reference image, to obtain the first perspective field parameter output by the image processing model.

10. The electronic device according to claim 8, wherein the processor is configured to execute following steps:
construct a camera model based on the simulated camera parameter, wherein the camera model is configured to describe a correspondence between a camera coordinate system and a pixel coordinate system; and
determine the first correspondence based on the camera model and a simulated gravity direction.

11. The electronic device according to claim 7, wherein the image shooting parameter comprises an image focal length, and the processor is configured to execute a following step:
determine a target focal length of the target device based on the image focal length and a standard focal length of the target device.

12. The electronic device according to claim 7, wherein the image shooting parameter comprises an image pitch angle, and the processor is configured to execute a following step:
determine a target pitch angle of the target device based on the image pitch angle and a gravity direction of the target device.

13. A non-transitory computer-readable storage medium, comprising instructions to instruct an electronic device to perform a method comprising:
obtaining a reference image;
determining an image shooting parameter of the reference image; and
determining a target shooting parameter based on the image shooting parameter and a camera parameter of a target device.

14. The non-transitory computer-readable storage medium according to claim 13, wherein the instructions instruct the electronic device to perform following steps:
determine a first perspective field parameter of the reference image;
determine a first correspondence between a simulated shooting parameter and a second perspective field parameter based on a simulated camera parameter; and
determine the image shooting parameter based on the first perspective field parameter and the first correspondence.

15. The non-transitory computer-readable storage medium according to claim 14, wherein the instructions instruct the electronic device to perform a following step:
invoke an image processing model to process the reference image, to obtain the first perspective field parameter output by the image processing model.

16. The non-transitory computer-readable storage medium according to claim 14, wherein the instructions instruct the electronic device to perform following steps:
construct a camera model based on the simulated camera parameter, wherein the camera model is configured to describe a correspondence between a camera coordinate system and a pixel coordinate system; and
determine the first correspondence based on the camera model and a simulated gravity direction.

17. The non-transitory computer-readable storage medium according to claim 13, wherein the image shooting parameter comprises an image focal length, and the instructions instruct the electronic device to perform a following step:
determine a target focal length of the target device based on the image focal length and a standard focal length of the target device.

18. The non-transitory computer-readable storage medium according to claim 13, wherein the image shooting parameter comprises an image pitch angle, and the instructions instruct the electronic device to perform a following step:
determine a target pitch angle of the target device based on the image pitch angle and a gravity direction of the target device.
